(19) United States
(12) Patent Application Publication
(10) Pub. No.: US 2019/0261602 A1
(43) Pub. Date: Aug. 29, 2019

(54) Tug-of-war Dog Toy

(71) Applicant: Victoria Mintz Powell, Raleigh, NC (US)

(72) Inventor: Victoria Mintz Powell, Raleigh, NC (US)

(21) Appl. No.: 16/286,872

(22) Filed: Feb. 27, 2019

Related U.S. Application Data
(60) Provisional application No. 62/636,684, filed on Feb. 28, 2018.

(51) Int. Cl. A01K 15/02

(52) U.S. Cl. CPC A01K 15/025

(57) ABSTRACT

The present invention is a dog toy for playing tug-of-war with a dog that has a handle and an elastic member attached to the handle and on the other side of the elastic member a bite toy wherein the elastic member can bend, stretch, and otherwise deform while the dog is pulling on the bite toy such that the elastic member absorbs some of the forces on the toy and decreases the amount of force acting on the handle and the owner's hand or wrist.

### CROSS-REFERENCE TO RELATED APPLICATIONS

Applicant is claiming the benefit of a prior-filed provisional application, Application No. 62/636,684 filed Feb. 28, 2018, under 35 U.S.C. 119(e), and states that the nonprovisional application was filed not later than 12 months after the date on which the provisional application was filed, and that the inventor is the same and the proper filing fee for the provisional application was paid.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable

### STATEMENT REGARDING PRIOR DISCLOSURES BY THE INVENTOR OR A JOINT INVENTOR

Not Applicable

### BACKGROUND OF THE INVENTION

Applicant's invention relates to the field of hand-held toys for pets. Currently, many devices are available that provide a means for pet owners to play with and entertain their pet. One of the most popular activities to engage in with pets, and especially dogs, are games of tug-of-war wherein a dog will pull on an object in one direction while its owner pulls on the object in the other direction. This activity has several advantages including providing exercise for the dog and strengthening the dog's teeth and jaw muscles. Further, this activity provides the means by which pet owners can bond with their pet through enjoyable, playful activities. It is clear that the need exists for devices with which dogs can interact with their owners. The present invention provides such a device.

It is an object of the present invention to provide a device with which an owner may engage in play with a dog. Applicant's device is an apparatus to facilitate the popular game of tug-of-war between a dog and its owner. Applicant's device overcomes many of the limitations found on the products currently available on the market. Most of the devices available today fall short of the ideal solution. Specifically, the devices available for an owner to play tug-of-war with a dog are rigid in their nature and can put unnecessary stress on the dog's teeth and jaw. When a dog clamps its jaw onto such a device, there is no leeway between the dogs tugging and the owners tugging, and therefore all of those forces are directly imparted to the dog's teeth through the device. Further, the same forces pulling against the dog's teeth are pulling against the owner's hand or wrist. As can be readily appreciated by those skilled in the art, if the pulling force exerted by the owner on the device is too great, it could strain or injure the owner's hand or the dog's teeth. Additionally, any rapid jerking motion of the device would transfer directly to the dog's teeth and owner's hand or wrist and could cause injury. Thus, a need exists for a device that can mitigate such forces protecting the owner and the animal from injury. Applicant's device achieves these goals.

A further need exists for a device that can be easily held by a dog owner while still engaging with a dog. The ability to securely hold a device is necessary for the game of tug-of-war as the dog pulls against the device and exerts forces on the device. Should the device slip out of the grasp of the owner, it could result in a jerking motion thereby injuring the dog or its teeth. A further need exists for a device that can withstand the pressures exerted by a dog's teeth. Thus, the device needs to be manufactured of a material sufficiently sturdy to withstand the significant forces exerted by dog's teeth on the device. Further, the device needs sufficient strength to maintain its integrity while being pulled in opposite directions by the owner and the dog. Moreover, the device needs to be manufactured such that the portion on which the dog's teeth will clamp will not damage the dog's teeth. Thus, the material comprising the device needs to be somewhat pliant.

### BRIEF SUMMARY OF THE INVENTION

Applicant's invention is designed to meet the needs of a dog toy designed to play tug-of-war. As discussed earlier, there is an absence of a suitable device with which to play tug-of-war with a dog that serves to mitigate the forces exerted by the device on the dogs teeth and owners hand or wrist. Applicant's invention is a device that includes a handle by which the owner may retain the device. In a preferred embodiment, the handle is formed by a loop allowing the owner to grasp the loop with the hand, or place the loop around the wrist such that the pulling force exerted by the dog will pull against the device and the handle.

The device also includes an elastic member extending from the handle outwardly toward the end of the device. The elastic member is designed such that it may expand or deform when placed under load from the forces exerted by the dog and owner pulling on the device. The elastic member is able to expand and contract while the device is being used such that it will mitigate pulling forces exerted by the owner and dog when playing the game of tug-of-war.

The end of the elastic member opposite of the handle is designed to attach to a bite toy or other object that the dog will grasp with its teeth. In a preferred embodiment this bite toy can be as simple as another piece of material, a rope, a ball, or other item which a dog can grasp in its teeth. It is further contemplated that the bite toy will be affixed to the elastic member such that it is able to rotate, twist, or otherwise move in any direction responsive to the tugging forces exerted by the dog's teeth.

When the owner and dog are engaged in a game of tug-of-war and the owner and the dog exert force on the device, the device expands due to the expansion of the elastic member. This expansion of the elastic member thereby mitigates some of the forces exerted on the owner's hand or wrist and the dog's teeth through the device. Such mitigation occurs when the pulling force is used to stretch the elastic member such that that some of the force transfers into the elastic member and not directly to the owner's hand or the dog's teeth. It should be appreciated by those skilled in the art that the elastic member can be of varying elasticity. This will allow the device to be used with small dogs that will not exert a large amount of force on the device, as well as larger dogs that would exert a great deal of force on the device. It is further contemplated that Applicant's device could be configured to have the ability to replace the elastic member with an alternate elastic member through various attachment schemes between the handle and the bite toy. Thus, when an owner desired to change the elastic member, it can be exchanged for a replacement elastic member. This allows the device to be used with a puppy and modified for use with a full-grown dog.

It is the intent of the present invention to provide a dog toy for playing with a dog that has a handle attached to an elastic member. The elastic member can be manufactured of any material as long as it possesses the ability to stretch and deform. The elastic member is attached to the handle on one end and attached to a bite toy on the other end of the elastic member.

It is another object of the present invention to provide a dog toy that also has a grip attached to the handle. The grip is designed to provide a secure hold on the dog toy for the owner while the dog is exerting forces on the dog toy during a game of tug-of-war. Also, the dog toy may have a first linkage secured to the handle and secured to the elastic member and a second linkage secured to the elastic member at the opposite end from the first linkage where the second linkage is also secured to the bite toy.

While there are many possible variants to the configuration of the dog toy, in a preferred embodiment the handle is configured in a loop shape. It is further contemplated that the first linkage is stitching composed of thread that secures the handle to the elastic member. It is contemplated that the second linkage is stitching that connects the elastic member to the bite toy.

The present invention is contemplated to provide a dog toy wherein the bite toy is a rope bent into a loop and encased by a sturdy material upon which a dog can clamp its teeth. It is further contemplated that the dog toy can be manufactured such that the elastic member can detach from the handle and the bite toy and be replaced. Further, because a dog's teeth will tend to wear and cause damage over time to a bite toy, the present invention provides for a dog toy wherein the bite toy is removable and can be replaced. The bite toy can be any number of different things including a rope, ball, bone, or other object a dog can grip with its teeth.

It is a still further object of the present invention to provide a dog toy for playing tug-of-war with a dog that includes a handle and an elastic member affixed to the handle. The elastic member can bend, stretch, and otherwise deform when force is exerted on it. The present invention also includes a bite toy affixed to the elastic member for a dog to grip with its teeth and pull during a game of tug-of-war whereby the elastic member will absorb some of the force and decrease the amount of force acting on the handle when a dog is pulling on the bite toy.

It is a still further object of the present invention to provide a dog toy including a grip attached to a handle and first linkage secured to the handle and secured to the elastic member. There is a second linkage secured to the elastic member at the opposite end from the first linkage and secured to a bite toy.

The objects and features of the current invention will be more clearly appreciated by examination of the following drawings, descriptions, and claims.

### BRIEF DESCRIPTION OF THE SEVERAL VIEWS OF THE DRAWING(S)

FIG. 1 is a top view of a preferred embodiment of Applicant's invention.

FIG. 2 is a top view of an alternate embodiment of Applicant's invention.

### DETAILED DESCRIPTION OF THE INVENTION

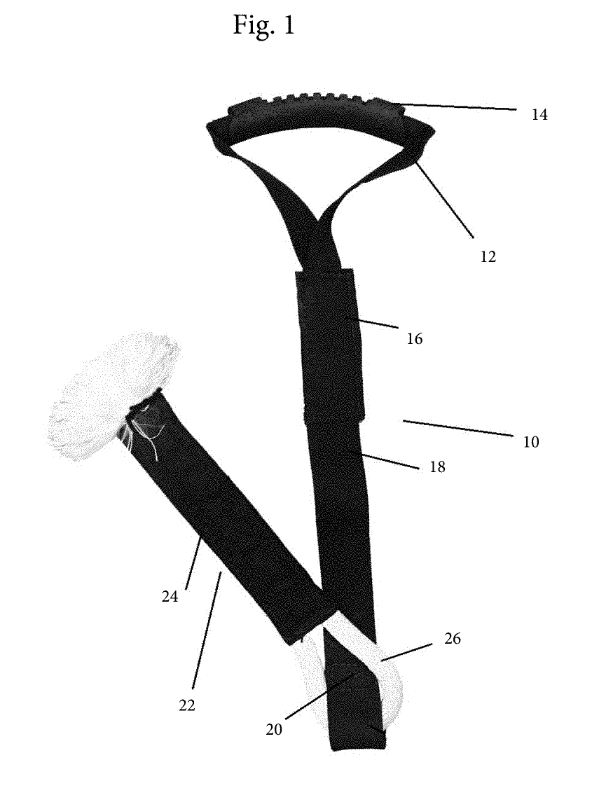

Referring now to FIG. 1 a dog toy 10 is shown. The dog toy 10 comprises a handle 12 that is configured from material and formed into the shape of a loop. In a preferred embodiment, a grip 14 is present on the handle 12 such that the pet owner can maintain a secure hold on the dog toy 10 while playing tug-of-war with a dog. The handle 12 is configured to attach to a first linkage 16 that is attached to an elastic member 18. The first linkage 16 can be as simple as stitching attaching the handle 12 to the elastic member 18. In a preferred embodiment, the first linkage 16 is a piece of material adjoining the handle 12 to the elastic member 18.

At the end of the elastic member 18 opposite from the handle 12 is a second linkage 20 that is configured to attach the elastic member 18 to a bite toy 22. The second linkage 20 like the first linkage 16 can be as simple as stitching that attaches the elastic member 18 to the bite toy 22. The bite toy 22 can be configured in many variations, and a preferred embodiment is shown in FIG. 1. The preferred bite toy 22 is a sturdy material 24 wrapped around a rope 26 that is looped through the second linkage 20 thereby attaching the bite toy 22 to the elastic member 18.

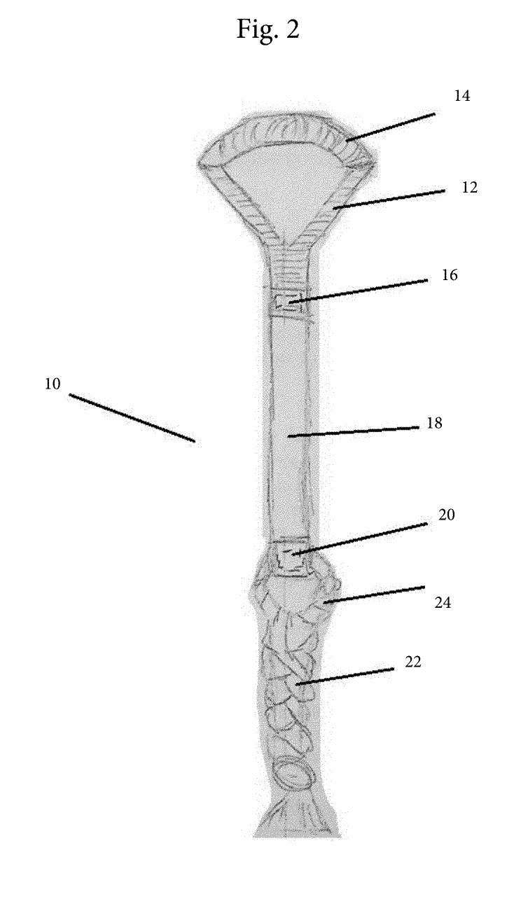

Referring now to FIG. 2, an alternate embodiment of the present invention is shown. This embodiment of Applicant's invention consists of five basic parts. The first part of this embodiment of Applicant's invention comprises a handle 12 that is formed into a loop shape that wraps around the pet owner's hand or wrist. The handle 12 is configured to have a grip 14 affixed to the handle 12 that provides a secure hold on the dog toy 10 for the owner's hand, and the grip 14 provides the ability to control the dog toy 10 as it is being pulled by a dog. The handle 12 is attached to a second part of Applicant's device which comprises a first linkage 16 that serves to fasten the handle 12 to the elastic member 18. The elastic member 18 extends outwardly from the first linkage 16 to a second linkage 20. The second linkage 20 is affixed to the opposite end of the elastic member 18 from the first linkage 16. The second linkage 20 is configured to accept any variants of a bite toy 22 that can be secured to the elastic member 18. It is contemplated that the bite toy 22 would be such things as plastic bones, balls, ropes, or other typical items a dog would chew or pull in a game of tug-of-war. It is further contemplated that this second linkage 20 be manufactured to contain a screw, clip, ring, or other conventional fastening device (not shown) with which it may attach to a selected bite toy 22 in a conventional manner. It is contemplated that the bite toy 22 be of such a nature that the dog will enjoy clamping its jaws on the bite toy 22 and pulling in a game of tug-of-war as the owner pulls the dog toy 10 in the opposite direction and away from the dog.

The elastic member 18 is manufactured such that it possesses elastic properties and can extend, stretch, bend, or otherwise deform when force is exerted upon the elastic member 18 by the dog pulling the bite toy 22. During a game of tug-of-war, a dog will typically shake its head back and forth exerting forces on the bite toy 22 in multiple directions. It is contemplated that the elastic member 18 of Applicant's device is manufactured such that it has the ability to flex and deform in the various directions in which the dog would typically move the bite toy 22. It is further contemplated that the elastic member 18 will have the ability to stretch such that some of the force exerted by the dog while pulling the bite toy 22 will transfer to the elastic member 18 instead of fully onto the dog's teeth and the owner's hand or wrist. The force required to stretch the elastic member 18 will diminish the totality of forces exerted against the dog's teeth and owner's hand or wrist by allowing some of the force to transfer to the elastic member 18. Thus, when the dog is pulling the bite toy 22 in the opposite direction from which the owner is pulling the handle 12 some of the force exerted on the dog toy 10 will be dissipated by the deformation of the elastic member 18.

It is further contemplated that the first linkage 16 and or second linkage 20 can also be equipped with the ability to stretch, bend, or otherwise deform when the dog toy 10 is under load. When the owner of the dog toy 10 is playing tug-of-war with the dog, the owner is pulling the handle 12 in the opposite direction from which the dog is pulling the bite toy 22. The resultant forces on the dog toy 10 are the forces exerted in opposite directions that will serve to stretch the elastic components of the dog toy 10. It is contemplated that the ability of the elastic member 18 to stretch will allow the elastic member 18 to deform under load but return to its natural, unstretched state when the forces acting upon it are removed. Thus, it is contemplated that the dog toy 10 will stretch and bend while being used and return to its normal shape once the game of tug-of-war is over.

It should be appreciated by those skilled in the art that the first linkage 16 and second linkage 20 that connect the elastic member 18 to the handle 12 on one end and the bite toy 22 on the other end of the dog toy 10 can be of any conventional design. All that is required is that the first linkage 16 and the second linkage 20 provide a secure manner to attach the bite toy 22 and the handle 12 to the elastic member 18 such that the dog toy 10 will not break apart during play.

It should be readily appreciated by those skilled in the art that numerous modifications and variations on the present invention are possible in light of the above teachings. It is therefore to be understood that the present invention and claims are intended to encompass and claim all such variants within the scope of the appended claims, and the invention shall not be limited to the preferred embodiments specifically described herein.

1. A dog toy for playing with a dog comprising:
A handle;
An elastic member attached to said handle; and
A bite toy attached to said elastic member.

2. A dog toy according to claim 1 further comprising:
A grip attached to said handle;
A first linkage secured to said handle and secured to said elastic member;
A second linkage secured to said elastic member at the opposite end from said first linkage and secured to said bite toy.

3. A dog toy according to claim 1 wherein said handle is configured in a loop shape.

4. A dog toy according to claim 2 wherein said first linkage is stitching.

5. A dog toy according to claim 2 wherein said second linkage is stitching.

6. A dog toy according to claim 1 wherein said bite toy is comprised of a rope bent into a loop and encased by a sturdy material upon which a dog can clamp its teeth.

7. A dog toy according to claim 1 wherein said elastic member is configured such that it can detach from said handle and said bite toy and be replaced.

8. A dog toy according to claim 1 wherein said bite toy is removable.

9. A dog toy according to claim 1 wherein said bite toy is a rope.

10. A dog toy according to claim 1 wherein said bite toy is a ball.

11. A dog toy according to claim 1 wherein said bite toy is a bone.

12. A dog toy for playing tug-of-war with a dog comprising:
A handle;
An elastic member affixed to said handle wherein said elastic member can bend, stretch, and otherwise deform when force is exerted on said elastic member;
A bite toy affixed to said elastic member whereby said elastic member will absorb some of the force and decrease the amount of force acting on said handle when a dog is pulling on said bite toy.

13. A dog toy according to claim 12 further comprising:
A grip attached to said handle;
A first linkage secured to said handle and secured to said elastic member;
A second linkage secured to said elastic member at the opposite end from said first linkage and secured to said bite toy.
